(19) United States
(12) Patent Application Publication
(10) Pub. No.: US 2023/0152114 A1
(43) Pub. Date: May 18, 2023

(54) APPARATUS AND METHOD FOR CONTROLLING HEAD UP DISPLAY OF VEHICLE

(71) Applicants: Hyundai Motor Company, Seoul (KR); Kia Corporation, Seoul (KR)

(72) Inventors: Ju Hyuk KIM, Suwon-Si (KR); Hui Won Shin, Hwaseong-Si (KR)

(73) Assignees: Hyundai Motor Company, Seoul (KR); Kia Corporation, Seoul (KR)

(21) Appl. No.: 17/891,459

(22) Filed: Aug. 19, 2022

(30) Foreign Application Priority Data
Nov. 15, 2021 (KR) 10-2021-0156933

(51) Int. Cl. G01C 21/36; G09G 3/00; G02B 27/01

(52) U.S. Cl. CPC G01C 21/3632; G09G 3/001; G01C 21/365; G02B 27/0101; G09G 2380/10; B60K 35/00

(57) ABSTRACT

An apparatus and method for controlling a head-up display of a vehicle includes a navigation device that determines a remaining distance from a location of the vehicle to a driving direction change point, a display device that displays vehicle information as an augmented reality image, and a controller configured for determining a vehicle speed at a point where the remaining distance is a specified distance, and determines a projection time point of the augmented reality image based on to the vehicle speed. Therefore, it is possible to provide a safe driving to the driver by allowing the driver to easily recognize the augmented reality image in consideration of the vehicle speed.

### CROSS-REFERENCE TO RELATED APPLICATION

The present application claims priority to Korean Patent Application No. 10-2021-0156933, filed on Nov. 15, 2021, the entire contents of which is incorporated herein for all purposes by this reference.

### BACKGROUND OF THE PRESENT DISCLOSURE

### Field of the Present Disclosure

The present disclosure relates to an apparatus and method for controlling a head-up display of a vehicle.

### Description of Related Art

A heads-up display may include a projection device that generates an augmented reality image. The augmented reality image generated by the projection device is reflected by a mirror and output to a windshield so that the augmented reality image is projected in front of the vehicle, allowing information on the vehicle to be easily recognized without dispersing the driver's field of vision. The augmented reality image is usually projected at a projection distance corresponding to the remaining distance from a location of the vehicle to a turning point.

However, when the vehicle speed is high while the remaining distance to the turning point is short, the time for which the augmented reality image is projected is reduced because the vehicle reaches the turning point rapidly, and accordingly, it is difficult for the driver to accurately recognize the augmented reality image.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and method for controlling a head-up display of a vehicle which can allow a driver to easily recognize an augmented reality image in consideration of a vehicle speed.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus of controlling a head-up display of a vehicle includes a navigation device that determines a remaining distance from a location of the vehicle to a driving direction change point, a display device that displays vehicle information as an augmented reality image, and a controller configured for determining a vehicle speed at a point where the remaining distance is a predetermined distance, and determines a projection time point of the augmented reality image based on to the vehicle speed.

The controller may be configured to control to start projecting the augmented reality image at a preset projection distance corresponding to an output height of the augmented reality image at a point where the remaining distance is a first set value when the controller concludes that the vehicle speed is less than a predetermined speed.

The controller may compare a projection distance preset corresponding to the output height of the augmented reality image with the remaining distance, and control to project the augmented reality image to the projection distance preset corresponding to the output height of the augmented reality image to a point where the remaining distance exceeds the projection distance.

The controller may be configured to control the augmented reality image to be projected by changing the output height by matching the remaining distance from a point at which the remaining distance is less than or equal to the preset projection distance.

The controller may be configured to control to start projecting the augmented reality image at a projection distance preset corresponding to the output height of the augmented reality image at a point where the remaining distance is a second set value greater than the first set value when the controller concludes that the vehicle speed is equal to or greater than the predetermined speed.

The controller may compare the projection distance preset corresponding to the output height of the augmented reality image with the remaining distance, and control to project the augmented reality image to the projection distance preset corresponding to the output height of the augmented reality image to a point where the remaining distance exceeds the projection distance.

The controller may be configured to control the augmented reality image to be projected by changing the output height by matching the remaining distance from a point at which the remaining distance is less than or equal to the preset projection distance.

According to another aspect of the present disclosure, a method of controlling a head-up display of a vehicle includes receiving a remaining distance from a location of the vehicle to a driving direction change point, determining a vehicle speed at a point where the remaining distance is a predetermined distance, and determining a projection time point of the augmented reality image based on to the vehicle speed.

The method may further include controlling to start projecting the augmented reality image at a preset projection distance corresponding to an output height of the augmented reality image at a point where the remaining distance is a first set value when the controller concludes that the vehicle speed is less than a predetermined speed.

The method may further include comparing a projection distance preset corresponding to the output height of the augmented reality image with the remaining distance, and controlling to project the augmented reality image to the projection distance preset corresponding to the output height of the augmented reality image to a point where the remaining distance exceeds the projection distance.

The method may further include controlling the augmented reality image to be projected by changing the output height by matching the remaining distance from a point at which the remaining distance is less than or equal to the preset projection distance.

The method may further include controlling to start projecting the augmented reality image at a projection distance preset corresponding to the output height of the augmented reality image at a point where the remaining distance is a second set value greater than the first set value when the controller concludes that the vehicle speed is equal to or greater than the predetermined speed.

The method may further include comparing the projection distance preset corresponding to the output height of the augmented reality image with the remaining distance, and controlling to project the augmented reality image to the projection distance preset corresponding to the output height of the augmented reality image to a point where the remaining distance exceeds the projection distance.

The method may further include controlling the augmented reality image to be projected by changing the output height by matching the remaining distance from a point at which the remaining distance is less than or equal to the preset projection distance.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating the configuration of an apparatus of controlling a head-up display of a vehicle according to an exemplary embodiment of the present disclosure;

FIG. 2A, FIG, 2B and FIG. 2C are diagrams illustrating an augmented reality image projected according to an exemplary embodiment of the present disclosure;

FIG. 3A, FIG. 3B and FIG. 3C are diagrams illustrating an augmented reality image projected according to an exemplary embodiment of the present disclosure;

FIG. 4 is a diagram illustrating a method of controlling a head-up display of a vehicle according to an exemplary embodiment of the present disclosure; and

FIG. 5 is a block diagram illustrating a computing system for executing a method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

In describing the components of the exemplary embodiment according to an exemplary embodiment of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

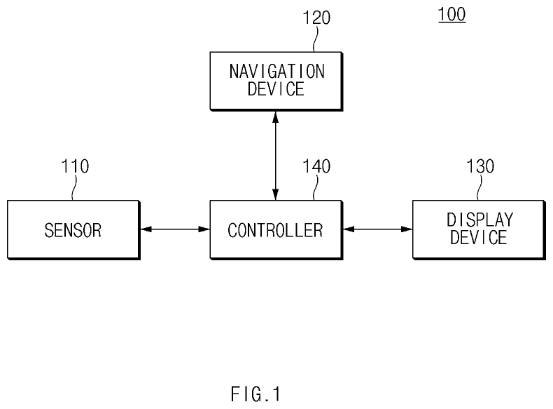

FIG. 1 is a block diagram illustrating the configuration of an apparatus of controlling a head-up display of a vehicle according to an exemplary embodiment of the present disclosure.

As shown in FIG. 1, an apparatus 100 for controlling a head-up display of a vehicle according to an exemplary embodiment of the present disclosure may include a sensor 110, a navigation device 120, a display 130 and a controller 140.

The sensor 110 may obtain state information of the vehicle. In the instant case, state information of the vehicle may include vehicle speed information. The sensor 110 may include a vehicle sensor configured for obtaining vehicle speed information.

The navigation device 120 may be provided with a Global Positioning System (GPS) receiver to receive the current location of the vehicle. The navigation device 120 may provide map information and route guidance information to a destination based on the current location of the vehicle. According to an exemplary embodiment of the present disclosure, the navigation device 120 may provide a route to a destination including at least one driving direction change point. The navigation device 120 may determine the remaining distance from the current location of the vehicle to the driving direction change point. Furthermore, the navigation device 120 may provide driving direction information at least one driving direction change point.

The display 130 may project an augmented reality image in front of the vehicle by outputting the augmented reality image to a windshield of the vehicle in an augmented reality (AR) head-up display scheme. In the instant case, the augmented reality image may include vehicle information. In the instant case, the vehicle information may include a current speed, information provided by the navigation device 120, time, external temperature, an amount of remaining fuel, a remaining distance to direction change, and the like.

The display 130 may include a projection device that generates an augmented reality image. The augmented reality image generated by the projection device may be reflected by a mirror and may be output to the windshield, so that the augmented reality image may be projected in front of the vehicle. The display 130 may adjust the output height of the augmented reality image output to the windshield by adjusting the angle of the mirror under control of the controller 140, and the distance projected in front of the vehicle may be adjusted corresponding to the output height of the augmented reality image. Accordingly, the lower the output height of the augmented reality image, the smaller the projection distance of the augmented reality image, and the higher the output height, the higher the projection distance of the augmented reality image.

According to an exemplary embodiment of the present disclosure, the output height of the augmented reality image may be preset based on vehicle information, and the display 130 may project the augmented reality image at a projection distance that matches the output height of the preset augmented reality image. For example, when the projection distance matching the preset output height at which the driving direction information is output is 50 m, the display 130 may project the driving direction information to a point spaced 50 m apart in front of the vehicle. Furthermore, when the projection distance matching the preset output height at which the current speed, the remaining distance, and the remaining distance to the change of direction are output is 5 m, the display 130 may project the driving direction information to a point spaced 5 m in front of the vehicle.

The controller 140 may be implemented with various processing devices such as a microprocessor in which a semiconductor chip configured for performing operation or execution of various commands is embedded, and the like, and may control the operation of a head-up display control device according to an exemplary embodiment of the present disclosure.

The controller 140 may receive the remaining distance (the remaining distance from the location of the vehicle to the driving direction change point) from the navigation device 120.

The controller 140 may determine the vehicle speed at the time point when the remaining distance is a specified distance. In the instant case, the specified distance may mean a distance through which the user can easily recognize the augmented reality image (driving direction information) regardless of the speed before reaching the direction change point. For example, the specified distance may be 200 m.

The controller 140 may determine a time point at which the augmented reality image is projected corresponding to the vehicle speed. According to an exemplary embodiment of the present disclosure, the controller 140 may determine whether the vehicle speed is less than a first speed at the time point when the remaining distance is a specified distance. When it is determined that the vehicle speed is less than the first speed at the time point when the remaining distance is the specified distance, the controller 140 may control the projection of the augmented reality image to start at the point where the remaining distance has a first set value. According to an exemplary embodiment of the present disclosure, the first speed may be set to 60 km/h.

When the controller 140 determines that the vehicle speed is less than the first speed, the controller 140 may control the augmented reality image to start to be projected at a preset projection distance corresponding to the output height of the augmented reality image at the point where the remaining distance is the first set value. In the instant case, the output height of the augmented reality image may be preset by the driver, and may be determined by the controller 140 in consideration of the driver's state (eye level, and the like).

According to an exemplary embodiment of the present disclosure, when the vehicle speed is less than 60 km/h, and the remaining distance from the location of the vehicle to the direction change point is 100 m, the controller 140 may control the augmented reality image to start to be projected at the preset projection distance corresponding to the output height of the augmented reality image. For example, when the projection distance preset corresponding to the output height of the augmented reality image is 37 m, and the vehicle speed is less than 60 km/h, the controller 140 may control the augmented reality image to start to be projected at a point where the remaining distance is 100 m to a point of 37 m in front of the vehicle.

After starting to project the augmented reality image to a preset projection distance corresponding to the output height of the augmented reality image at the point where the remaining distance is the first set value, the controller 140 may compare the projection distance preset corresponding to the remaining distance and the output height of the augmented reality image with the remaining distance so that it is possible to maintain the projection of the augmented reality image at the projection distance preset corresponding to the output height of the augmented reality image to a point where the remaining distance exceeds the projection distance. As an exemplary embodiment of the present disclosure, when the remaining distance is reduced from 100 m but exceeds 37 m, the controller 140 may keep the augmented reality image projected to a point of 37 m in front of the vehicle.

When the remaining distance decreases as the vehicle travels while maintaining the projection of the augmented reality image to a preset projection distance corresponding to the output height of the augmented reality image, the controller 140 may control the augmented reality image to be projected by changing the output height by matching the remaining distance from a point where the remaining distance is equal to or less than the projection distance preset corresponding to the output height of the augmented reality image. That is, the controller 140 may control the augmented reality image to be projected by matching the remaining distance with the projection distance and changing the output height of the augmented reality image to an output height corresponding to the projection distance. As an exemplary embodiment of the present disclosure, the controller 140 may control the augmented reality image to be projected by changing the output height by matching the remaining distance from a point where the remaining distance is equal to or less than 37 m.

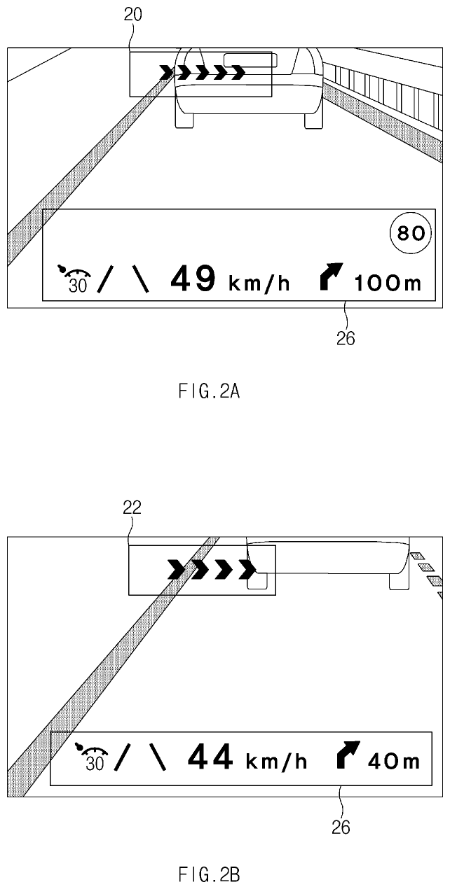

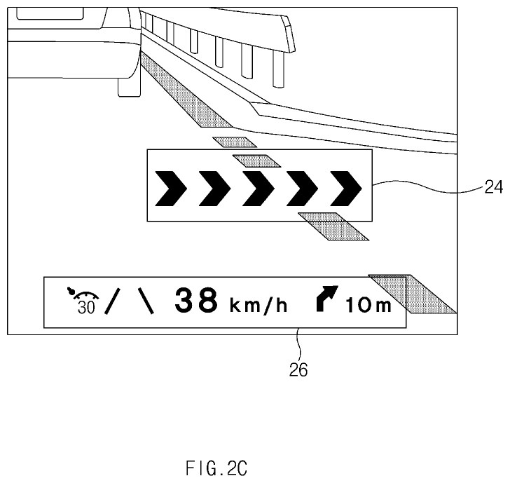

More details will be described with reference to FIG. 2A, FIG, 2B and FIG. 2C.

FIG. 2A, FIG, 2B and FIG. 2C are diagrams illustrating an augmented reality image projected according to an exemplary embodiment of the present disclosure.

As shown in FIG. 2A, the controller 140 may project the driving direction information, the current speed, the remaining distance, and the remaining distance to the change of direction as an augmented reality image. When the projection distance corresponding to the preset output height is 37 m and it is determined that the vehicle speed is less than the first speed by determining the vehicle speed when the remaining distance is the specified distance, the controller 140 may control driving direction information 20 to start to be projected at the projection distance (e.g., 37 m) corresponding to the output height of the augmented reality image from the point, wherein the remaining distance is the first set value.

As shown in FIG. 2B, when the remaining distance decreases as the vehicle travels, the controller 140 may compare the remaining distance with the projection distance (e.g., 37 m) corresponding to the output height of the augmented reality image. When it is determined that the remaining distance is 40 m, the controller 140 may maintain the projection of an augmented reality image 22 at a point of 37 m in front of the vehicle because the remaining distance exceeds the projection distance.

As shown in FIG. 2C, when it is determined that the remaining distance is 10 m, the controller may project an augmented reality image 24 by matching the remaining distance to change the output height because the remaining distance is less than the projection distance.

Furthermore, as shown in FIG. 2A, FIG, 2B and FIG. 2C, the controller 140 may project the augmented reality images 20, 22 and 24 according to the remaining distance and at the same time, may project an augmented reality image 26 corresponding to basic information to a projection distance corresponding to a preset output height, where the basic information includes the current speed, the remaining distance, and the remaining distance to the direction change. In the instant case, the augmented reality image 26 corresponding to the basic information may be projected at different output heights to be distinguished from the augmented reality images 20, 22 and 24 including the direction change information.

Meanwhile, when determining that the vehicle speed is equal to or greater than the first speed, the controller 140 may set a starting point at which the augmented reality image is projected to be earlier. As an exemplary embodiment of the present disclosure, the controller 140 may control the augmented reality image to start to be projected at a preset projection distance corresponding to the output height of the augmented reality image at a point where the remaining distance is the second set value greater than the first set value. In the instant case, the output height of the augmented reality image may be preset by the driver, and may be determined by the controller 140 in consideration of the driver's state (eye level, and the like).

According to an exemplary embodiment of the present disclosure, when the vehicle speed is equal to or greater than 60 km/h, and the remaining distance from the location of the vehicle to the direction change point is 150 m, the controller 140 may control the augmented reality image to start to be projected at the preset projection distance corresponding to the output height of the augmented reality image. That is, when the vehicle speed is fast, the controller 140 may advance the time at which the augmented reality image is output compared to when the vehicle speed is slow so that the time for which the augmented reality image is projected increases, increasing the time for which the driver recognizes it.

For example, when the projection distance preset corresponding to the output height of the augmented reality image is 37 m, and the vehicle speed is 60 km/h or more, the controller 140 may control the augmented reality image to start to be projected at a point where the remaining distance is 150 m to a point of 37 m in front of the vehicle.

After starting to project the augmented reality image to a preset projection distance corresponding to the output height of the augmented reality image at the point where the remaining distance is the first set value, the controller 140 may compare the projection distance preset corresponding to the remaining distance and the output height of the augmented reality image with the remaining distance so that it is possible to maintain the projection of the augmented reality image at the projection distance preset corresponding to the output height of the augmented reality image to a point where the remaining distance exceeds the projection distance. As an exemplary embodiment of the present disclosure, when the remaining distance is reduced from 150 m but exceeds 37 m, the controller 140 may keep the augmented reality image projected to a point of 37 m in front of the vehicle.

When the remaining distance decreases as the vehicle travels while maintaining the projection of the augmented reality image to a preset projection distance corresponding to the output height of the augmented reality image, the controller 140 may control the augmented reality image to be projected by changing the output height by matching the remaining distance from a point where the remaining distance is equal to or less than the projection distance preset corresponding to the output height of the augmented reality image.

That is, the controller 140 may control the augmented reality image to be projected by matching the remaining distance with the projection distance and changing the output height of the augmented reality image to an output height corresponding to the projection distance. As an exemplary embodiment of the present disclosure, the controller 140 may control the augmented reality image to be projected by changing the output height by matching the remaining distance from a point where the remaining distance is equal to or less than 37 m.

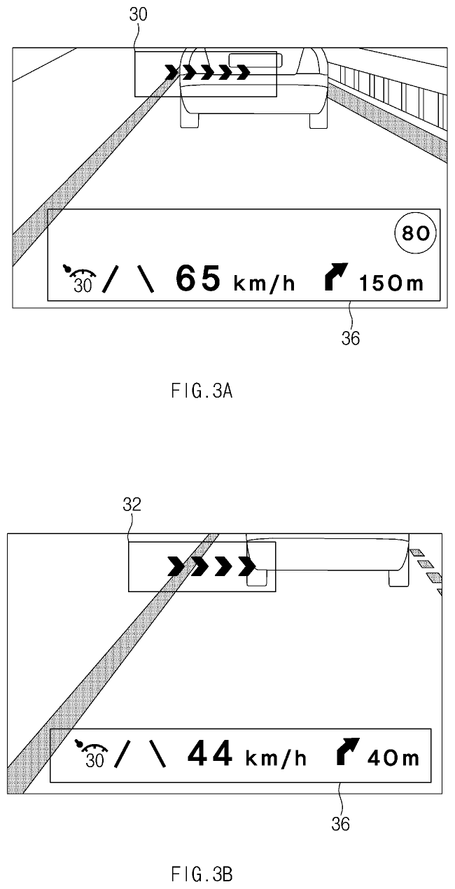

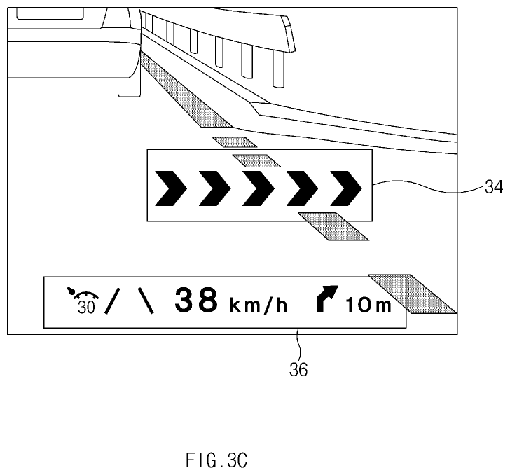

More details will be described with reference to FIG. 3A, FIG. 3B and FIG. 3C.

FIG. 3A, FIG. 3B and FIG. 3C are diagrams illustrating an augmented reality image projected according to an exemplary embodiment of the present disclosure.

As shown in FIG. 3A, the controller 140 may project the driving direction information, the current speed, the remaining distance, and the remaining distance to the change of direction as an augmented reality image. When the projection distance corresponding to the preset output height is 37 m and it is determined that the vehicle speed is equal to or greater than the first speed by determining the vehicle speed when the remaining distance is the specified distance, the controller 140 may control driving direction information 30 to start to be projected at the projection distance (e.g., 37 m) corresponding to the output height of the augmented reality image from the point, wherein the remaining distance is the second set value. That is, the augmented reality image may be output at a time earlier than the time at which the augmented reality image is output in FIG. 2A.

As shown in FIG. 3B, when the remaining distance decreases as the vehicle travels, the controller 140 may compare the remaining distance with the projection distance (e.g., 37 m) corresponding to the output height of the augmented reality image. When it is determined that the remaining distance is 40 m, the controller 140 may maintain the projection of an augmented reality image 32 at a point of 37 m in front of the vehicle because the remaining distance exceeds the projection distance.

As shown in FIG. 3C, when it is determined that the remaining distance is 10 m, the controller 140 may project an augmented reality image 34 by matching the remaining distance to change the output height because the remaining distance is less than the projection distance.

Furthermore, as shown in FIG. 3A, FIG. 3B and FIG. 3C, the controller 140 may project the augmented reality images 30, 32 and 34 according to the remaining distance and at the same time, may project an augmented reality image 36 corresponding to basic information to a projection distance corresponding to a preset output height, where the basic information includes the current speed, the remaining distance, and the remaining distance to the direction change. In the instant case, the augmented reality image 36 corresponding to the basic information may be projected at different output heights to be distinguished from the augmented reality images 30, 32 and 34 including the direction change information.

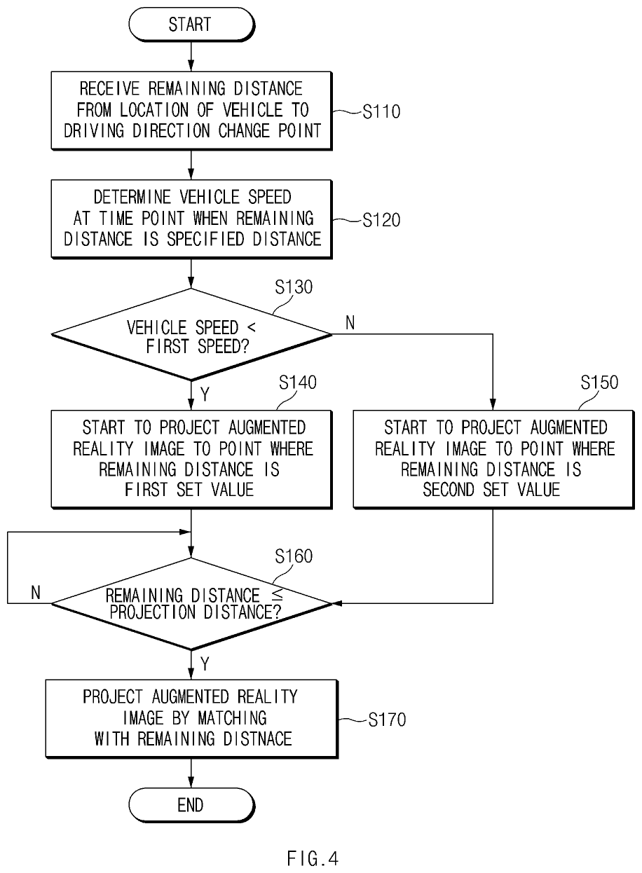

FIG. 4 is a diagram illustrating a method of controlling a head-up display of a vehicle according to an exemplary embodiment of the present disclosure.

As shown in FIG. 4, in S110, the controller 140 may receive the remaining distance (the remaining distance from the location of the vehicle to the driving direction change point) from the navigation device 120.

In S120, the controller 140 may determine the vehicle speed at the time point when the remaining distance is a specified distance. In the instant case, the specified distance may mean a distance through which the user can easily recognize the augmented reality image (driving direction information) regardless of the speed before reaching the direction change point. For example, the specified distance may be 200 m.

In S130, the controller 140 may determine whether the vehicle speed is less than the first speed when the remaining distance is a specified distance. When it is determined in S130 that the vehicle speed is less than the first speed when the remaining distance is the specified distance (Y), in S140, the controller 140 may control the augmented reality image to start being projecting at the point where the remaining distance is the first set value. According to an exemplary embodiment of the present disclosure, the first speed may be set to 60 km/h.

In S140, the controller 140 may control the augmented reality image to start being projected at a preset projection distance corresponding to the output height of the augmented reality image at the point where the remaining distance is the first set value. In the instant case, the output height of the augmented reality image may be preset by the driver, and may be determined by the controller 140 in consideration of the driver's state (eye level, and the like).

According to an exemplary embodiment of the present disclosure, when the vehicle speed is less than 60 km/h, and the remaining distance from the location of the vehicle to the direction change point is 100 m, the controller 140 may control the augmented reality image to start to be projected at the preset projection distance corresponding to the output height of the augmented reality image. For example, when the projection distance preset corresponding to the output height of the augmented reality image is 37 m, and the vehicle speed is less than 60 km/h, the controller 140 may control the augmented reality image to start to be projected at a point where the remaining distance is 100 m to a point of 37 m in front of the vehicle.

The controller 140 may compare the remaining distance with the preset projection distance corresponding to the remaining distance and the output height of the augmented reality image. According to an exemplary embodiment of the present disclosure, in S160, the controller 140 may determine whether the remaining distance is equal to or less than the projection distance.

When it is determined in S160 that the remaining distance is not equal to or less than the projection distance (N), the controller may keep the augmented reality image projected at the preset projection distance corresponding to the output height of the augmented reality image to the position where the remaining distance exceeds the projection distance. As an exemplary embodiment of the present disclosure, when the remaining distance exceeds 37 m, the controller 140 may keep the augmented reality image projected at a point 37 m in front of the vehicle.

The controller 140 may control the augmented reality image to be projected by changing the output height by matching the remaining distance from a point where the remaining distance is equal to or less than the projection distance preset corresponding to the output height of the augmented reality image. In S170, the controller 140 may control the augmented reality image to be projected by matching the remaining distance with the projection distance and changing the output height of the augmented reality image to an output height corresponding to the projection distance. As an exemplary embodiment of the present disclosure, the controller 140 may control the augmented reality image to be projected by changing the output height by matching the remaining distance from a point where the remaining distance is 37 m or less.

Meanwhile, when it is determined in S130 that the vehicle speed is equal to or greater than the first speed, the controller 140 may set a starting point at which the augmented reality image is projected to be earlier. As an exemplary embodiment of the present disclosure, in S150, the controller 140 may control the augmented reality image to start to be project at a preset projection distance corresponding to the output height of the augmented reality image at a point where the remaining distance is the second set value greater than the first set value. In the instant case, the output height of the augmented reality image may be preset by the driver, and may be determined by the controller 140 in consideration of the driver's state (eye level, and the like).

According to an exemplary embodiment of the present disclosure, when the vehicle speed is equal to or greater than 60 km/h, and the remaining distance from the location of the vehicle to the direction change point is 150 m, in S150, the controller 140 may control the augmented reality image to start to be projected at the preset projection distance corresponding to the output height of the augmented reality image. That is, when the vehicle speed is fast, the controller 140 may advance the time at which the augmented reality image is output compared to when the vehicle speed is slow so that the time for which the augmented reality image is projected increases, increasing the time for which the driver recognizes it.

For example, when the projection distance preset corresponding to the output height of the augmented reality image is 37 m, and the vehicle speed is 60 km/h or more, the controller 140 may control the augmented reality image to start to be projected at a point where the remaining distance is 150 m to a point of 37 m in front of the vehicle.

Thereafter, the controller 140 may perform S160 and S170.

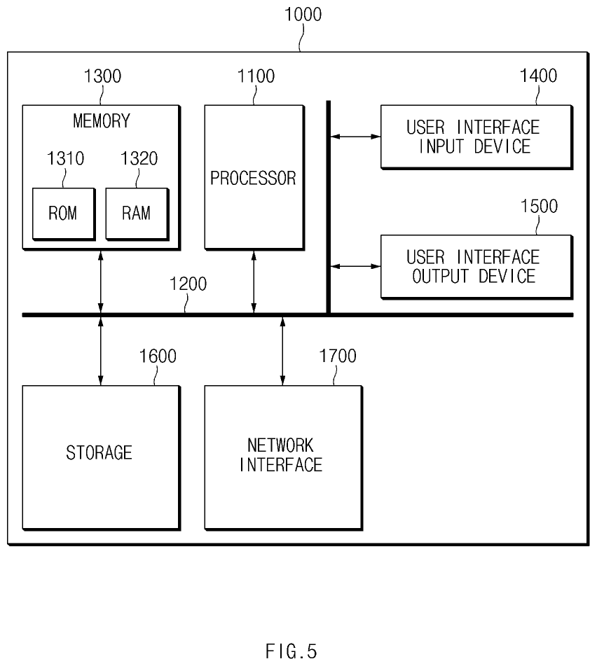

FIG. 5 is a block diagram illustrating a computing system for executing a method according to an exemplary embodiment of the present disclosure.

Referring to FIG. 5, a computing system 1000 may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The apparatus and method for controlling a head-up display of a vehicle according to an exemplary embodiment of the present disclosure may provide a safe driving to the driver by allowing the driver to easily recognize the augmented reality image in consideration of the vehicle speed.

Although exemplary embodiments of the present disclosure have been described for illustrative purposes, those skilled in the art will appreciate that various modifications, additions and substitutions are possible, without departing from the scope and spirit of the present disclosure.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of controlling a head-up display of a vehicle, the apparatus comprising:
a navigation device configured to determine a remaining distance from a location of the vehicle to a driving direction change point;
a display device configured to display vehicle information as an augmented reality image; and
a controller electrically connected to the navigation device and the display device and configured to determine a vehicle speed at a point where the remaining distance is a predetermined distance, and determine a projection time point of the augmented reality image based on to the vehicle speed.

2. The apparatus of claim 1, wherein the controller is configured to control to start projecting the augmented reality image at a preset projection distance corresponding to an output height of the augmented reality image at a point where the remaining distance is a first set value when the controller concludes that the vehicle speed is less than a predetermined speed.

3. The apparatus of claim 2, wherein the controller is configured to compare a projection distance preset corresponding to the output height of the augmented reality image with the remaining distance, and control to project the augmented reality image to the projection distance preset corresponding to the output height of the augmented reality image to a point where the remaining distance exceeds the projection distance.

4. The apparatus of claim 3, wherein the controller is configured to control the augmented reality image to be projected by changing the output height by matching the remaining distance from a point at which the remaining distance is less than or equal to the preset projection distance.

5. The apparatus of claim 2, wherein the controller is configured to control to start projecting the augmented reality image at a projection distance preset corresponding to the output height of the augmented reality image at a point where the remaining distance is a second set value greater than the first set value when the controller concludes that the vehicle speed is equal to or greater than the predetermined speed.

6. The apparatus of claim 5, wherein the controller is configured to compare the projection distance preset corresponding to the output height of the augmented reality image with the remaining distance, and control to project the augmented reality image to the projection distance preset corresponding to the output height of the augmented reality image to a point where the remaining distance exceeds the projection distance.

7. The apparatus of claim 6, wherein the controller is configured to control the augmented reality image to be projected by changing the output height by matching the remaining distance from a point at which the remaining distance is less than or equal to the preset projection distance.

8. A method of controlling a head-up display of a vehicle, the method comprising:
receiving, by a controller, a remaining distance from a location of the vehicle to a driving direction change point;
determining, by the controller, a vehicle speed at a point where the remaining distance is a predetermined distance; and
determining, by the controller, a projection time point of the augmented reality image based on to the vehicle speed.

9. The method of claim 8, further including:
controlling, by the controller, to start projecting the augmented reality image at a preset projection distance corresponding to an output height of the augmented reality image at a point where the remaining distance is a first set value when the controller concludes that the vehicle speed is less than a predetermined speed.

10. The method of claim 9, further including:
comparing, by the controller, a projection distance preset corresponding to the output height of the augmented reality image with the remaining distance, and controlling to project the augmented reality image to the projection distance preset corresponding to the output height of the augmented reality image to a point where the remaining distance exceeds the projection distance.

11. The method of claim 10, further including:
controlling, by the controller, the augmented reality image to be projected by changing the output height by matching the remaining distance from a point at which the remaining distance is less than or equal to the preset projection distance.

12. The method of claim 9, further including:
controlling, by the controller, to start projecting the augmented reality image at a projection distance preset corresponding to the output height of the augmented reality image at a point where the remaining distance is a second set value greater than the first set value when the controller concludes that the vehicle speed is equal to or greater than the predetermined speed.

13. The method of claim 12, further including:
comparing, by the controller, the projection distance preset corresponding to the output height of the augmented reality image with the remaining distance, and controlling, by the controller, to project the augmented reality image to the projection distance preset corresponding to the output height of the augmented reality image to a point where the remaining distance exceeds the projection distance.

14. The method of claim 13, further including:
controlling, by the controller, the augmented reality image to be projected by changing the output height by matching the remaining distance from a point at which the remaining distance is less than or equal to the preset projection distance.

15. A non-transitory computer readable storage medium on which a program for performing the method of claim 8 is recorded.
